(19) United States
(12) Patent Application Publication
(10) Pub. No.: US 2005/0027466 A1
(43) Pub. Date: Feb. 3, 2005

(54) Wireless collection of battery performance metrics system, method, and computer program product

(76) Inventors: Jay Steinmetz, Baltimore, MD (US); Jonathan Hochman, West Hartford, CT (US); Eric Olsson, Baltimore, MD (US)

Correspondence Address: TOWNSEND & BANTA, 601 PENNSYLVANIA AVE N.W., SUITE 900, SOUTH BLDG, WASHINGTON, DC, 20004, US

(21) Appl. No.: 10/742,991

(22) Filed: Dec. 23, 2003

Related U.S. Application Data
(60) Provisional application No. 60/490,523, filed on Jul. 29, 2003.

(51) Int. Cl. G06F 19/00

(52) U.S. Cl. 702/63

(57) ABSTRACT

A system, method and computer program product are provided, including: (a) receiving a plurality of battery output metrics from at least one mobile device having a battery over a communication network at a central station; and (b) analyzing the plurality of battery output metrics at the central station. The method can include: (c) storing the plurality of battery output metrics in a database with an index associated with the at least one mobile device. The communication network can include a local area network (LAN) or a wide area network (WAN), can be wireless or wired, or can include an IEEE standard 802.11-compliant wireless communication network. Alternatively, the method can include a step (c) comparing analyzed battery performance metrics of a first of the at least one mobile device with analyzed battery performance metrics of a second of the at least one mobile device.

### FIELD OF THE INVENTION

The present invention relates to the field of batteries. More particularly, this invention relates to batteries for computing devices and systems and methods for collecting battery metrics for such batteries.

### BACKGROUND OF THE INVENTION

Batteries are a conventionally well-known energy source for powering electronic devices, such as, e.g., mobile phones, notebook computers, handheld computing or communication devices and various other portable electronic devices. All batteries have two terminals, a positive terminal and a negative terminal. Batteries work by causing electrons to collect on the negative terminal. Negatively charged electrons then travel from the negative terminal to the positive terminal of the battery over a circuit commonly referred to as a “load.” The load couples the positive and negative terminals to one another. The electrons are produced by a chemical reaction in the battery. The rate of production of the electrons determines how many electrons can flow between the terminals. A battery thus generates a direct current (DC) to energize loads or devices. A battery is rated at a voltage level (e.g., 1.5 volts, 9 volts, 12 volts, etc.) Batteries are often rechargeable, meaning that the chemical reaction can be reversed. Some batteries are completely reversible, some suffer from memory effects, and vary in power to weight ratios depending on the batteries' chemistry. Examples of batteries include, e.g., alkaline, lead-acid, lead-iodide, lithium, lithium-iodide, metal chloride, nickel-cadmium (“NI—CAD”), nickel-metal hydride (“NMH”), lithium ion, zinc-air, zinc-carbon, zinc mercury oxide, silver-zinc among other types of commonly available battery types. With the advent of the mobile worker, an ever-greater number of employees rely on battery power to provide productivity while untethered from a desk using, e.g., wireless computing and/or communication devices. Unfortunately, since battery life is limited, inevitably, a battery will run low in power, requiring recharging or replacement with a charged battery. When a battery runs low, the mobile worker relying on the battery for energizing a personal productivity communications or computing device, will as a result become unproductive.

Conventional approaches to deal with batteries losing their charge have dealt with monitoring of motor vehicle batteries, and with monitors on a battery that can be used to send an end-of-life alert message to a technician. For example, U.S. Pat. 6,522,267 (“the '267 patent”) was issued for a wireless system to monitor motor vehicle batteries. The system of the '267 patent includes the ability to notify a central station if the vehicle battery is low. Unfortunately however, solutions designed for motor vehicle batteries do not take into account the particular requirements of batteries for mobile communication and computing devices and fall short of the particular needs of the user of such a mobile device.

U. S. Pat. 6,545,448 (“the '448 patent) issued for a battery monitor that can send an end-of-life warning message over the Internet or via a wireless transceiver to a secretary or technician. The system of the '448 patent requires a mobile device to evaluate the performance of its battery. Similarly, sending a notification when a mobile device has evaluated an end-of-life condition for a battery also falls short in addressing the needs of mobile devices in today's mobile working environment. To the extent that the '267 and '448 patents are relevant as background to the present application, their contents are incorporated herein by reference in their entirety.

A large enterprise may have dozens, hundreds, or thousands of mobile devices in service at a particular location. An example would be a radio frequency (RF) wireless barcode scanner that can record an identity of an outgoing package at a warehouse loading dock. A mobile worker may scan several packages per minute using the RF wireless barcode scanner. If the battery in the RF wireless barcode scanner fails, the worker stops working and wastes time hunting for a new battery, resulting in lost worker productivity. Moreover, a battery may not merely need to be recharged—the battery may instead be worn out and therefore incapable of being recharged properly.

Also, there is a risk that a line worker may mistakenly install an incorrect battery into a mobile device which could damage the device or result in unreliable operation. A battery may also fail and not be noticed immediately. The sooner failure is detected and corrected, the less user productivity is lost. Thus, it is an object of the present invention to provide an improved technique of identifying a battery's performance status.

### SUMMARY OF THE INVENTION

In order to achieve the object of the invention described above, a system, method, and computer program product for gathering remotely monitored battery output metrics and centrally analyzing and compiling statistics on battery performance is provided. Further, as a component of the system, method and computer program product described above, the present invention can store battery output metrics in a database.

For example, in a first embodiment of the present invention, a method is provided comprising the steps of:

(a) receiving a plurality of battery output metrics from at least one mobile device having a battery over a communication network at a central station; and

(b) analyzing the plurality of battery output metrics at the central station.

In a second embodiment of the present invention according to the first embodiment above, the method further comprises (c) storing the plurality of battery output metrics in a database with an index associated with the at least one mobile device.

In a third embodiment of the present invention according to the first embodiment above, the communication network includes a local area network (LAN) or a wide area network (WAN).

In a fourth embodiment of the present invention according to the first embodiment above, the communication network includes a wireless network or a wired network.

In a fifth embodiment of the present invention according to the first embodiment above, the communication network includes an IEEE standard 802.11-compliant wireless communication network.

In a sixth embodiment of the present invention, the method of the first embodiment above further comprises (c) comparing analyzed battery performance metrics of a first of the at least one mobile device with analyzed battery performance metrics of a second of the at least one mobile device.

In a seventh embodiment of the present invention, a system for collecting battery output metrics at a central station is provided, comprising:

a receiving means for receiving a plurality of battery output metrics from at least one mobile device having a battery over a communication network at a central station; and

an analyzing means for analyzing the plurality of battery output metrics at the central station, responsive to the receiving means.

In an eighth embodiment of the present invention, a system operative to collect and analyze battery performance at a central station is provided, comprising:

a central station operative to receive a plurality of battery output metrics from at least one mobile device having a battery over a communication network at the central station; and

a battery performance analyzer operative to analyze the plurality of battery output metrics at the central station.

In a ninth embodiment of the present invention, a computer program product embodied on a computer readable medium comprising program logic for centrally collecting and analyzing battery performance is provided, comprising:

a receiving means for enabling a computer to receive a plurality of battery output metrics from at least one mobile device having a battery over a communication network at a central station; and

an analyzing means for enabling the computer to analyze the plurality of battery output metrics at the central station, responsive to the receiving means.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digits in the corresponding reference number.

### BRIEF DESCRIPTION OF THE DRAWINGS

The foregoing and other features and advantages of the invention will be apparent from the following, more particular description of exemplary embodiments of the invention, as illustrated in the accompanying drawings. A preferred embodiment is included below in the detailed description of the following drawings:

FIG. 1 depicts an exemplary embodiment of a wireless mobile battery monitoring system according to the present invention.

### DETAILED DESCRIPTION OF THE INVENTION

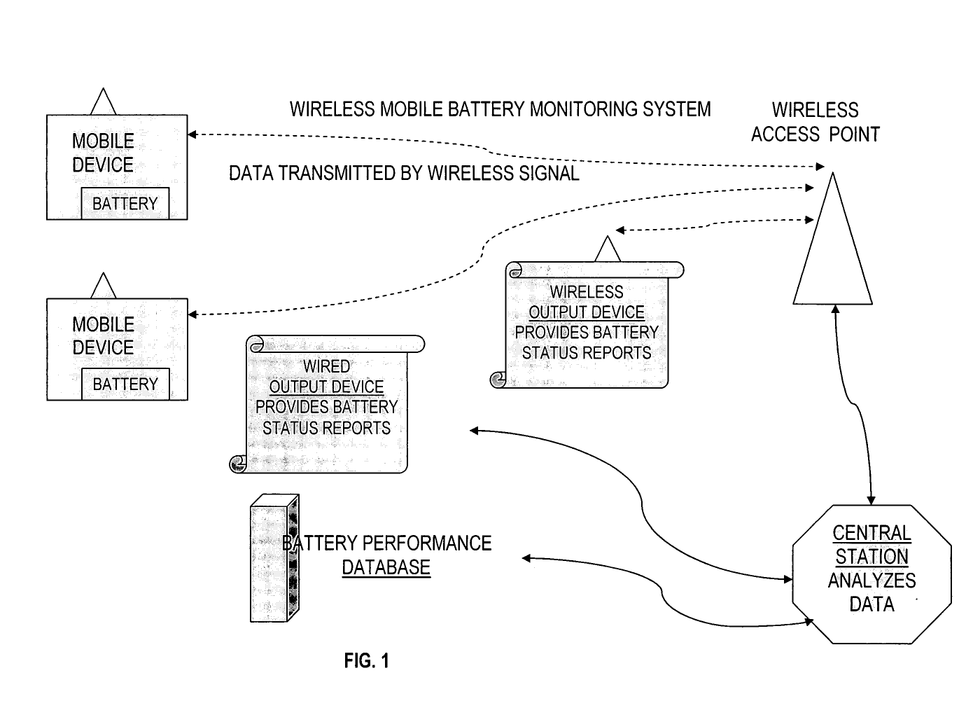

FIG. 1 depicts an exemplary embodiment of a high level system block diagram 100 of a wireless mobile battery monitoring system according to the present invention. The high level system block diagram includes, in an exemplary embodiment, several exemplary mobile devices that each include a battery. The mobile devices can be remote in location from a central station in an exemplary embodiment of the present invention. The mobile devices can communicate with the central station via a network. In an exemplary embodiment, the network can be a local area network (LAN) or a wide area network (WAN). In another exemplary embodiment, the network can be a wireless network.

For example, the mobile device can communicate over an IEEE standard 802.11 compliant wireless LAN via, e.g., a wireless access point (AP) as shown in FIG. 1. In an exemplary embodiment, battery status reports can be viewed, displayed or outputted. As shown in the exemplary embodiment of FIG. 1, such battery status reports can be provided via an output device such as, e.g., a wireless, or a wired output device, shown coupled to a central station. Further, as shown in the exemplary embodiment of FIG. 1, battery performance data and other useful information can be stored in a database.

An exemplary embodiment of the present invention enables monitoring battery maintenance in a fleet of mobile devices to reduce the number of mobile device failures that interrupt business operations. Today and into the future there are large numbers of mobile devices operating within many business enterprises performing mission critical functions. Battery failure is by far the leading cause of mobile device failure and downtime. All enterprises can use a centralized system, according to an exemplary embodiment of the present invention, to monitor the performance of batteries to ensure prompt maintenance of mobile devices to avoid disruption of critical business processes.

Previous approaches did not include a centralized database for storage, query and analysis of battery performance data. Having a centralized database of battery performance metrics can be very valuable. The database can be used to support making strategic decisions, such as choosing battery suppliers based on actual statistical performance of their products in use at the enterprise. Another use for the database is to plan mobile device utilization schedules and activities to minimize the number of battery failures occurring at critical times.

Conventional approaches have looked at battery performance as an issue for the mobile device and the operator of the mobile device. The present invention looks at battery power as a critical system-wide resource that is centrally monitored and managed for the enterprise to achieve maximum efficiency.

Conventional approaches rely upon on-board diagnostic programs. Many mobile devices need to be constructed as small and power efficient as possible. Therefore, it is desirable to simplify and minimize the on-board diagnostic programming as much as possible to free up available memory, to reduce power consumption, and to allow for miniaturization of the mobile devices. The present invention minimizes the consumption of mobile device resources (i.e. power, memory, processor cycles) by conducting all analytical functions at the central station.

A shortcoming of conventional approaches is that conventionally, information necessary to analyze battery performance must be replicated and stored on each portable computing device, or mobile device. When an enterprise uses hundreds or thousands of mobile devices, keeping each device up to date on new battery design specifications is extremely burdensome. The present invention can store all criteria for analyzing and evaluating battery performance at the central station. Battery technology is continuously improving as new batteries are developed and introduced. When new batteries are developed, only the central station needs to be updated according to the present invention, not a large number of mobile devices.

The present invention in an exemplary embodiment can be installed on a portable communications or computing device (the “mobile device”), such as, e.g., a portable computer, a personal digital assistant (PDA), a mobile, or cellular telephone, or a handheld terminal, and a networked computing device designated as a the “central station.” The mobile device according to an exemplary embodiment of the present invention can include any portable device with a battery, wireless network communications ability (i.e. the ability to communicate by a communications protocol such as, e.g., an industry standard-compliant IEEE 802.11 type of wireless communications protocol), an internal clock, and logic circuits sufficient to collect, at least briefly store, and relay data. The battery can include, e.g., any device which can store energy in any form and can output electrical energy as a power source.

The mobile device, in an exemplary embodiment, can be designed, constructed and programmed so that an application program running on the mobile device can access information about the battery. The battery information can include, e.g., an output voltage or an amperage. In addition, the mobile device may optionally provide other information to the application program including, e.g., both output voltage and amperage, whether the device is currently being recharged, the device's unique identification number (such as a media access control (MAC) identifier in wireless communications circuitry), the battery's unique identification number, the operator's identity (if the device allows the operator to identify himself or herself by logging in), and the mobile device's location. The mobile device application program can collect the aforementioned information, in one exemplary embodiment, at set intervals (or whenever requested by the central station) and can transmit the information to the central station by a wireless protocol.

The invention can include an application program running on the central station. The central station application can receive data from the mobile devices by a wireless communications protocol, or by a wired communications protocol linked to a distinct wireless signal relaying device (such as, e.g., an access point). The incoming data can be stored in a database for analysis. The data can be evaluated in real time to compare battery performance metrics to design specifications or other data.

The central station can evaluate voltage and amperage over time, and can calculate an approximate integral of the function “voltage times amperage” for comparison to the battery's design energy storage capacity. The approximated integral can be calculated by collecting voltage and amperage at fixed intervals and then by summing up the result of multiplying the voltage, amperage and interval length.

When a mobile device's battery's performance falls outside of design limits in one of the following ways, the central station in an exemplary embodiment can issue an alert:

1. Loss of data transmission—suspected “total failure” fault. The central station can immediately query the affected mobile device asking it to retransmit the last data set. If after a specified number of tries the mobile device fails to communicate with the central station, then the central station can declare a fault.

2. Voltage falls below design specification—suspected “battery needs recharge” fault. The central station can take steps to remedy the situation such as, e.g., exchanging batteries, or recharging the battery.

3. Voltage exceeds design specification—suspected “incorrect battery installed” fault. The central station can again take remedial action to achieve replacement of the incorrectly installed battery with a proper battery.

Depending on the use and capabilities of the mobile device, one or both of the following conditions can be monitored by the system according to the present invention:

1. The approximate integral of the function of the product of “voltage times amperage” indicates that insufficient energy was stored in the battery, when measured over the time from last recharge until the time of near-discharge (as indicated by voltage falling below design specification)—suspected “battery's ability to recharge is insufficient” fault.

2. Voltage falls below design specification after less time than the minimum designed operating time of the battery (i.e. time since last recharge is too short)—suspected “battery's ability to recharge is insufficient” fault.

The alert can contain valuable diagnostic and operational information such as, e.g., suspected nature of the battery fault, the time, the mobile device's identity, the operator's identity, and the location of the mobile device (for example, coordinates determined by the device's onboard GPS circuitry, connected Access Points' coordinates, or triangulation with multiple connected Access Points). The fault may be due to, e.g., destruction or removal of the battery, a battery needing recharge, a rechargeable battery no longer capable of being recharged properly, or an incorrect battery installed in the mobile device.

The format of the alert message is flexible depending on the particular needs of the user and the particular design of the mobile device. The alert message could be a text message. The alert message could be a voice message generated by a networked computing device. It could be multimedia message including text, sounds/voice and/or graphics. The alert message could be a graph representing the battery performance of a set of mobile devices.

The central station can forward or display the alerts to any type of computer or communications device connected to a network. For example, alerts can be forwarded to computing devices such as, e.g., desktop computers, notebooks, servers, workstations, and communications devices such as, e.g., wired or wireless terminals, a personal digital assistant (PDA), a mobile telephone, a landline telephone, a beeper, a speaker, a monitor, a printer, or a fax device.

In an exemplary embodiment of the present invention, transmitting mobile device battery performance metrics can be sent together with other data, such as, e.g., time, mobile device ID, Operator ID, or mobile device location to a central station by, e.g., a wireless network from a mobile device. The network could be an IEEE 802.11, or 802.16 standard compliant wireless network, or alternatively could include a wired or other wireless type network. A central station can collect and analyze battery performance metrics, accompanied by other useful data, from a set of mobile devices according to exemplary embodiments.

In another exemplary embodiment of the present invention, the system can monitor for premature voltage drop relative to the amount of energy that has been drawn from the battery over time. The integral of the function of the product of voltage times amperage over the time since last recharge is equal to the energy stored and used. Every mobile device has a battery designed to store a minimum amount of energy so the device can perform a minimal number of useful functions before the battery must be recharged. After repeated charging and discharging, batteries tend to lose the ability to store energy. When the battery's capability to store energy degrades below its design threshold, then the battery should be repaired or discarded.

In yet another exemplary embodiment of the present invention, the system can transmit information to a central station by wireless network that can allow the central station to determine the existence and nature of a battery fault. An exemplary embodiment of the present invention can also collect and/or store battery performance metrics in a central station database.

In an exemplary embodiment of the present invention, the system can include a mobile device that can be adapted to include circuits that can be built in for monitoring battery voltage, current flow, and a clock.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to a preferred embodiment, it will be understood to those having ordinary skill in the art that changes in the above description or illustrations may be made with respect to formal detail without departing from the spirit and scope of the invention.

1. A method of collecting and analyzing battery metrics comprising the steps of:
(a) receiving a plurality of battery output metrics from at least one mobile device having a battery over a communication network at a central station; and
(b) analyzing said plurality of battery output metrics at said central station.

2. The method of claim 1, further comprising:
(c) storing said plurality of battery output metrics in a database with an index associated with said at least one mobile device.

3. The method of claim 1, wherein said communication network comprises at least one of a local area network (LAN) and a wide area network (WAN).

4. The method of claim 1, wherein said communication network comprises at least one of a wireless network and a wired network.

5. The method of claim 1, wherein said communication network comprises an IEEE standard 802.11-compliant wireless communication network.

6. The method of claim 1, further comprising:
(c) comparing analyzed battery performance metrics of a first of said at least one mobile device with analyzed battery performance metrics of a second of said at least one mobile device.

7. A system for collecting battery output metrics at a central station comprising:
receiving means for receiving a plurality of battery output metrics from at least one mobile device having a battery over a communication network at a central station; and analyzing means for analyzing said plurality of battery output metrics at said central station, responsive to said receiving means.

8. A system operative to collect and analyze battery performance at a central station comprising:
a central station operative to receive a plurality of battery output metrics from at least one mobile device having a battery over a communication network; and
a battery performance analyzer operative to analyze said plurality of battery output metrics at said central station.

9. The system according to claim 8, wherein said mobile devices comprises at least one of:
a computing device;
a desktop computer;
a notebook;
a server;
a workstation;
a communications device;
a wired terminal;
a wireless terminal;
a personal digital assistant (PDA);
a mobile telephone;
a landline telephone;
a beeper;
a speaker;
a monitor;
a printer; and
a fax device.

10. A computer program product embodied on a computer readable medium comprising program logic for centrally collecting and analyzing battery performance, comprising:
receiving means for enabling a computer to receive a plurality of battery output metrics from at least one mobile device having a battery over a communication network at a central station; and
analyzing means for enabling the computer to analyze said plurality of battery output metrics at said central station, responsive to said receiving means.
